(19) United States
(12) Patent Application Publication
(10) Pub. No.: US 2008/0273651 A1
(43) Pub. Date: Nov. 6, 2008

(54) Methods and apparatus for reducing artifacts in computed tomography images

(76) Inventor: Franz Edward Boas, Palo Alto, CA (US)

Correspondence Address: Franz Edward Boas, 440 Monroe Dr, Palo Alto, CA, 94306, US

(21) Appl. No.: 11/744,850

(22) Filed: May 5, 2007

(51) Int. Cl. G01N 23/00; G06K 9/40

(52) U.S. Cl. 378/4; 382/275

(57) ABSTRACT

We present an iterative method for reducing artifacts in computed tomography (CT) images. In each iteration, constraints such as non-negativity are applied, then the image is blurred to guide convergence to a smoother image. Next, the image is modified using an algebraic reconstruction algorithm to try to match the projection data to within the experimental error. A mask is calculated which specifies which parts of the image to update during each iteration. The mask allows us to first solve regions of the image that are determined by rays with low photon counts (and thus high error). Then, regions of the image determined by rays with higher photon counts (and thus lower error), are solved using those ray sums. Reducing CT scan artifacts results in clearer and higher resolution images, faster scan times, and less radiation use.

### BACKGROUND OF THE INVENTION

A computed tomography (CT) scanner uses X-rays to determine the three-dimensional structure of an object. X-ray beams (“rays”) are passed through the object from different angles, and detectors on the other side measure the intensity of each attenuated ray. Here, “ray” refers to the path traversed by X-rays between the source and a single detector. All of the detector measurements for a single fixed X-ray source and detector configuration are referred to as a “projection.” The complete set of projections (“projection data”) can also be expressed as “ray sums,” which provide information on the sum of the X-ray attenuation coefficients along each ray. “Ray sums” can also be obtained using other imaging modalities, such as positron emission tomography (PET), or single photon emission computed tomography (SPECT). For these other imaging modalities, “ray sum” refers to the sum of the emitter densities along a given path. The ray sums are then reconstructed into a three dimensional model (“CT image” or “reconstructed image”) of the object using a method such as filtered back projection (FBP), an algebraic reconstruction algorithm such as the algebraic reconstruction technique (ART), or Fourier reconstruction.

Given exact projection data with infinite resolution, these methods can reconstruct the object perfectly. However, given noisy data with limited resolution or missing data values, the reconstructed image can contain incorrect elements (“artifacts”) such as streaking or starburst patterns 5 (as shown in FIG. 2). This is particularly true around high X-ray attenuation (“density”) materials such as bone or metal. These artifacts are typically caused by the increased error associated with low photon counts, beam hardening effects, edge effects, scatter, etc.

Several strategies have been proposed to reduce artifacts in CT images. A beam hardening correction can be applied as a pre-processing step, or as an iterative correction based on the current reconstructed image. Noisy projection data can be replaced with interpolated or smoothed data. The ART method can be modified to converge to a maximum likelihood (ML), maximum entropy, or minimum norm solution. (B. De Man, et al, “Reduction of metal streak artifacts in x-ray computed tomography using a transmission maximum a posteriori algorithm,” IEEE transactions on nuclear science, vol. 47, no. 3, pp. 977-81, June 2000; S. Vandenberghe, et al, “Iterative reconstruction algorithms in nuclear medicine,” Computerized medical imaging and graphics, vol. 25, pp. 105-11, 2001; D. Verhoeven, “Limited-data computed tomography algorithms for the physical sciences,” Applied optics, vol. 32, no. 20, pp. 3736-54, Jul. 10, 1993)

Some artifacts still remain after using these existing methods. For example, the maximum likelihood method tries to find an image that has the highest probability of generating the projection data, assuming that photon counts in each detector follow a Poisson distribution. This ignores other sources of error, such as scatter, edge effects, or errors in the beam hardening correction. Furthermore, there are many images consistent with the projection data within experimental error, and the maximum likelihood method does not specify which image to pick. Thus, the final reconstructed image depends on the initial image, and how many maximum likelihood iterations are applied.

Here, we present a method for CT artifact reduction that addresses these issues. Reducing the artifacts for a given level of noise results in clearer and higher resolution images, faster scan times, and less radiation use.

### SUMMARY OF THE INVENTION

Our CT reconstruction method is guided by two key insights. First, ray sums corresponding to fewer photon counts are less accurate, so the reconstruction method should not try to match these ray sums as closely. Second, there are many reconstructed images that are consistent with the data (given the error), so we should pick one that has the fewest unnecessary spikes in density, and that has positive density everywhere.

In one embodiment of the present invention, we start with an initial estimate of the CT image, which can be generated by an existing CT reconstruction method. This initial estimate is then iteratively corrected to reduce artifacts. In each iteration, constraints such as non-negativity of X-ray attenuation coefficients, may be applied first. Next, the image is blurred to guide convergence to a smoother image with fewer artifacts. Finally, the image is modified using an algebraic reconstruction algorithm to try to match the projection data to within the experimental error. Notice that the final image is not blurred, because the correction step ensures that the image is still consistent with the projection data. However, any local variations in density that are not supported by the projection data are blurred out.

In the embodiment described in the previous paragraph, the entire image is updated in each iteration. In a variation on this embodiment, a mask is calculated for each iteration which specifies which parts of the image will be updated on that iteration. The use of a mask allows us to first solve regions of the image that are determined by rays with low photon counts (and thus high error). Then, regions of the image determined by rays with higher photon counts (and thus lower error), are solved using those ray sums.

This invention addresses the major sources of artifacts in CT images. Poisson counting error (shot noise) is directly incorporated into the experimental error model. Scatter and beam-hardening effects can be treated by pre-processing the projection data. Any remaining errors can then be incorporated into the experimental error model. Even if the experimental error model is wrong, the use of a mask allows data from rays with high photon counts to override data from rays with low photon counts. The mask also allows data from rays away from an edge to override data from rays near an edge, thus suppressing edge artifacts. Finally, the blurring step allows the method to pick a smooth image, out of the large set of images consistent with the projection data. Thus, good images can be obtained even for very fast scans that generate less projection data than necessary to uniquely specify an image.

### BRIEF DESCRIPTION OF THE DRAWINGS

FIG. 1A is a flowchart showing the steps performed in one variation.

FIGS. 1B and 1C show examples of how step S2 may be performed.

FIG. 2 shows CT images generated using filtered back projection, and using an embodiment of the present invention.

FIG. 3 diagrams some of the conventions used in the source code listed below.

### DETAILED DESCRIPTION OF THE INVENTION

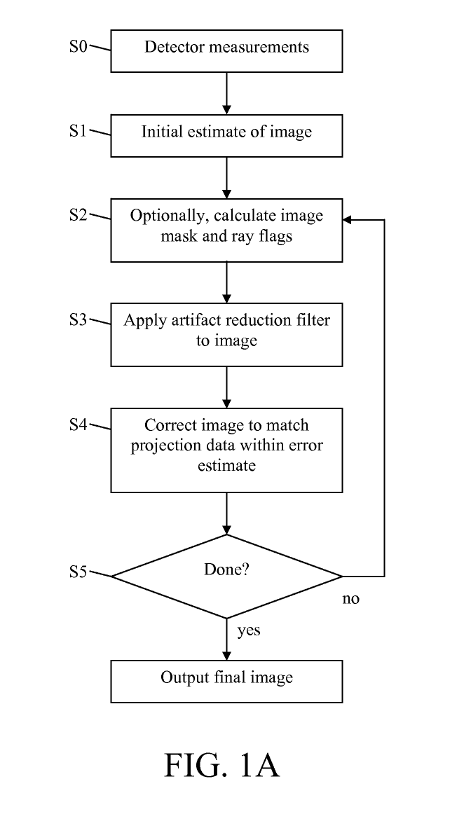

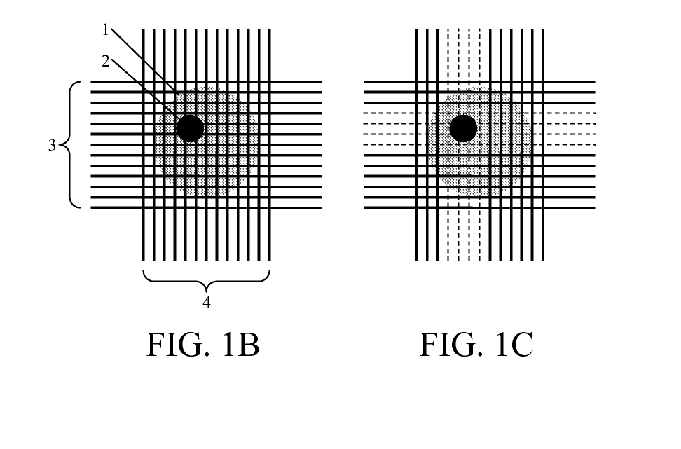

A flowchart showing one embodiment is illustrated in FIG. 1A and described in detail below.

Step S0. Projection data are obtained from a plurality of detectors configured to detect transmitted, emitted, or reflected photons, other particles, or other types of radiated energy. These measurements are made by a CT, PET, SPECT, or other type of scanner.

Step S1. The projection data can be pre-processed to account for beam-hardening, scatter, refraction, diffraction, or other phenomena. Furthermore, low photon counts from nearby rays can be averaged together to reduce the error. The projection data can be interpolated to generate a higher resolution data set. The projection data can be filtered to account for cross-talk between the detectors, or to reduce noise. Many other pre-processing techniques are known to those in the art.

The initial estimate of the CT image is then generated by an existing CT reconstruction method, such as filtered backprojection. The artifact reduction steps (steps S2-S5) could be performed on all slices (two dimensional cross sections) of the image, or only on slices that contain significant artifacts. The initial estimate of the CT image can also be initialized with a uniform image, or some other fixed image. Typically, the image will be represented as a regular array of density elements, such as pixels or voxels.

Step S2. A mask is calculated to determine which parts of the CT image to update on the current iteration. The mask could cover the entire image, or it could be restricted to portions of the image. Also, a subset of rays are flagged, indicating that they can be used to update the image. Alternatively, all of the rays may be flagged.

In one variation, rays with photon counts above a given cutoff are flagged. In order to be flagged, nearby rays may also be required to have photon counts above a given cutoff. Nearby rays may be specified using a Euclidian or other distance metric, or may be specified in a look-up table or other function. The mask consists of portions of the image for which greater than a certain number of flagged rays pass through. The various cutoffs may be varied in each iteration. For example, all rays might be flagged in the initial iterations, then in later iterations, the photon count cutoff could be gradually increased to the point where the error in each flagged ray has decreased to an acceptable level.

This step is diagrammed in FIGS. 1B and 1C. The object being scanned has a low density region 1 and a high density region 2. Projection data are acquired from multiple angles (3 and 4). Initially (FIG. 1B), all rays and image regions are considered. In later iterations (FIG. 1C), rays with low photons counts and their neighbors (thin dashed lines) are ignored.

In another variation, the mask includes regions of the current CT image below a density cutoff (such as bone or metal density). Alternatively, the mask can include density elements of the current CT image for which all density elements within a distance cutoff are below a density cutoff. Then, rays that only pass through the mask are flagged. The various cutoffs may be changed in each iteration.

Step S3. An artifact reduction filter is applied to the image to reduce spurious variations in density, while attempting to preserve legitimate image details. Only masked density elements are modified during this step. The artifact reduction filter may be changed in each iteration. Constraints may be applied to the current image prior to the artifact reduction step.

In one embodiment, all density elements with negative density are set to zero. Then, an edge-preserving blurring filter is applied. Specifically, each density element in the new image is calculated as the arithmetic average of nearby density elements inside a circular region centered on the corresponding element in the current image. Only density elements with densities similar to the center density element are included in the average (the difference in density should be below a given cutoff). The blurring radius can be changed in each iteration, depending on the amount of artifact or noise remaining in the image.

Alternatively, instead of an arithmetic average, one could use a weighted average, median, mode, trimmed mean, or other function. A similar result could be obtained using a low-pass filter, Fourier-transform-based filter, convolution, Fourier-transform-based convolution, noise-reduction filter, another edge-preserving blurring filter, or another artifact reduction filter. Many other variations will be apparent to those skilled in the art.

Step S4. The CT image is modified to try to match the projection data to within the experimental error. Only masked density elements are modified during this step, and only flagged rays are considered.

In one embodiment, simulated projection data are calculated for the current CT image (this procedure is called “forward projection”). Each simulated ray sum is calculated as a weighted sum of the density elements along that ray. The ray sum error is the experimental ray sum minus the simulated ray sum. A fraction of this error is then added to each of the density elements of the image that contributed to that ray sum (this procedure is called “backprojection”). These fractions add to 1, and they are proportional to the weight used to calculate that density element's contribution to that ray sum. Other ways of distributing the ray sum error are possible: for example, higher density elements can receive a proportionally greater fraction of the error. Backprojecting the ray sum errors makes the image consistent with the experimental ray sums. Typically, all of the ray sum errors associated with a single projection are calculated and backprojected, and then constraints, such as non-negativity of density elements, may be applied. Then, this process is repeated for all of the other projections. The projections can be considered in sequential order, random order, spaced 90° or 60° apart, or in some other order, so as to improve the rate of convergence. Alternatively, another algebraic reconstruction method, filtered backprojection, or another CT reconstruction method can be applied to the ray sum errors to generate a correction image that is added to the current CT image. Non-additive methods for updating the CT image, such as multiplicative ART, are also known. The correction procedure described in this paragraph may be repeated multiple times.

The ray sum errors may be adjusted to incorporate error estimates for the projection data. In one embodiment, the ray sum error is set to 0 if the simulated ray sum falls within the error limits for the experimental ray sum. Otherwise, the ray sum error is set equal to the simulated ray sum subtracted from the closest error limit for the experimental ray sum. More generally, the ray sum error can be scaled down using a formula based on the experimental error estimate, the simulated ray sum, and the experimental ray sum. Alternatively, the iterative least squares technique (ILST) directly incorporates the error estimate into the quantity being minimized, the sum of squared deviations.

For Poisson error, the error limits on the number of photons detected are approximately:

(photons detected)±(standard deviations)×\sqrt{(photons detected)+1}

To account for other types of error (such as beam-hardening effects, scatter, refraction, diffraction, edge effects, or non-linearities in the detector measurement), other formulas or lookup tables may be used to estimate the error in the projection data.

Step S5. The iterative corrections are continued for a given number of iterations (typically between 1 and 1000), or until termination criteria are met. For example, the procedure could be terminated when the maximum change in density, or the average change in density, or the root-mean-square change in density during the previous iteration falls below a given threshold.

In this step, the projection data can be corrected for beam hardening, scatter, refraction, diffraction, or other effects, using the current CT image. Many methods for doing this are known to those in the art.

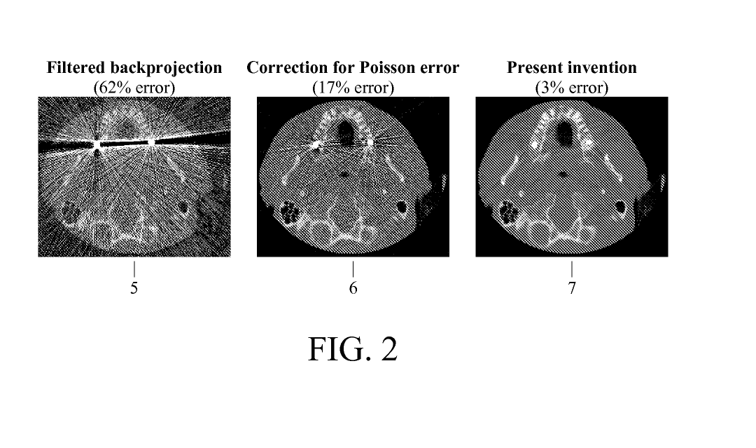

FIG. 2 shows CT images generated using filtered back projection 5, using a method that only corrects for Poisson error 6 (FIG. 1A, skipping steps S2 and S3), and using an embodiment described herein 7 (FIG. 1A). The density of the dental fillings is 100× the density range seen in the soft tissue and bone. The CT image has a resolution of 416×344 pixels, and was reconstructed from projections from 400 different angles, where each projection had parallel rays spaced 1 pixel apart. The error is a root-mean-square error expressed as a percentage of the range of densities seen in the soft tissue and bone. The number of photons per detector ranged between 0 and 10⁶, with an average of 6.0×10⁵.

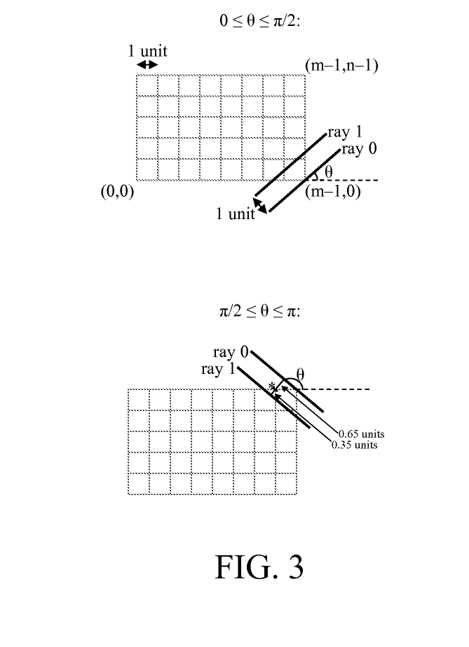

FIG. 3 shows the conventions used in the source code. Projections are taken of an m×n pixel image from multiple angles, using parallel rays spaced 1 pixel apart. In the figure, pixels are represented by intersections between grid lines. Only two rays are shown in the figure, but in reality the rays cover the entire image. Pixels that fall between rays are assigned a fractional weight for each ray. For example, the pixel next to the asterisk (*) is 0.65 units away from ray 0, and 0.35 units away from ray 1. Thus, when calculating ray sums, ray 0 will receive 0.35×the density of the pixel next to the asterisk, and ray 1 will receive 0.65×the density of the pixel next to the asterisk. When backprojecting error corrections along each ray, the same weights are used to determine the proportion of the error correction that each pixel will receive.

An example of the C++ source code, using the conventions shown in FIG. 3, is presented below. For simplicity and clarity, the code shows the case of two dimensional CT reconstructions from parallel rays. However, the code can be modified to handle three dimensional CT scans, cone beam projections, helical CT, multi-slice CT, emission tomography (such as PET or SPECT), and other cases. Furthermore, the method may be implemented in software on a general purpose processor, or it may be implemented in specialized hardware, such as an application specific integrated circuit (ASIC), or Field Programmable Gate Array (FPGA).

Specific embodiments of this invention have been described in detail for purposes of clarity. However, it should be understood that the invention is not intended to be limited to the particular forms disclosed. Rather, the invention covers all modifications, equivalents, and alternatives falling within the spirit and scope of the invention as defined by the following claims.

In the claims section, the term “and/or” in a list refers to all or any subset of the list, excluding the empty set.

What is claimed is:

1. A method for calculating an image consistent with a plurality of ray sums, comprising:
at least one artifact reduction step, in which a filter is applied to the image such that artifacts are reduced; and
at least one correction step, in which the image is updated to match the ray sums more closely, and wherein said correction step occurs after an artifact reduction step.

2. The method of claim 1, wherein said artifact reduction step comprises a linear or nonlinear filter, such as: calculating each density element in the new image as an arithmetic average, a weighted average, a linear combination, a median, a mode, a trimmed mean, or some other function of nearby density elements in the current image; or said artifact reduction step comprises a low-pass filter, a Fourier-transform-based filter, a convolution, a Fourier-transform-based convolution, an edge-preserving blurring filter, a despeckling filter, or a noise-reducing filter; and said nearby density elements may be specified using a Euclidian or other distance metric, or may be specified in a lookup table or other function; and said nearby density elements may be further specified based on their density, the density of elements near them, and/or the density of elements near the element being calculated.

3. The method of claim 2, wherein said artifact reduction step additionally comprises a constraint step, wherein the densities of the density elements are constrained to lie within a given range, and said constraint step may occur before or after the steps described in claim 2.

4. The method of claim 1, wherein said correction step further comprises calculating the estimated error in the experimental projection data, and updating the image to match the experimental projection data, using the error estimate.

5. The method of claim 4, wherein said correction step further comprises calculating simulated ray sums for the current image, and setting the target ray sum to the simulated ray sum if the simulated ray sum falls within the error limits for the experimental ray sum, and otherwise setting the target ray sum to the error limit for the experimental ray sum that is closest to the simulated ray sum.

6. The method of claim 4, wherein said correction step further comprises calculating simulated ray sums for the current image, calculating a ray sum error by differencing or dividing the experimental and simulated ray sums, then adjusting each ray sum error using a formula based on the unadjusted ray sum error, the experimental error estimate, the simulated ray sum, and/or the experimental ray sum.

7. The method of claim 1, wherein said correction step is performed using an algebraic reconstruction technique, multiplicative algebraic reconstruction technique, simultaneous iterative reconstruction technique, simultaneous algebraic reconstruction technique, iterative least squares technique, another algebraic reconstruction algorithm, maximum likelihood expectation maximization, filtered backprojection, or another CT reconstruction method.

8. The method of claim 1, wherein a subset of density elements in the image are updated in each step.

9. The method of claim 1, wherein a subset of ray sums are used to update the image.

10. The method of claim 9, wherein only the subset of rays with photon counts above a given cutoff are considered in each step, and nearby rays may also be required to have photon counts above a given cutoff, wherein said nearby rays may be specified using a Euclidian or other distance metric, or may be specified in a look-up table or other function; and wherein only portions of the image for which greater than a certain number of rays in said subset of rays pass through are updated in each step.

11. A method for calculating an image consistent with a plurality of ray sums, comprising:
at least one artifact reduction step, in which an edge-preserving blurring filter is applied to the image; and
at least one constraint step, in which the densities of the density elements are constrained to lie within a given range; and
at least one correction step, in which the image is updated to match the ray sums to within the experimental error, wherein said correction step occurs after an artifact reduction step.

12. The method of claim 11, wherein only a subset of the density elements in the image are updated in each step, and/or wherein only a subset of the ray sums are used to update the image.

13. A computed tomography system comprising:
a plurality of detectors configured to detect transmitted, emitted, or reflected photons, other particles, or other types of radiated energy; and
a processor configured to calculate an image from the detector signals, wherein the processor calculates an image consistent with a plurality of ray sums, by performing at least one artifact reduction step, in which a filter is applied to the image such that artifacts are reduced; and performing at least one correction step, in which the image is updated to match the ray sums more closely, and wherein said correction step occurs after an artifact reduction step.

14. A computed tomography system comprising:
a plurality of detectors configured to detect transmitted, emitted, or reflected photons, other particles, or other types of radiated energy; and
a processor configured to calculate an image from the detector signals, wherein the processor calculates an image consistent with a plurality of ray sums, by performing at least one artifact reduction step, in which an edge-preserving blurring filter is applied to the image; and performing at least one constraint step, in which the densities of the density elements are constrained to lie within a given range; and performing at least one correction step, in which the image is updated to match the ray sums to within the experimental error, wherein said correction step occurs after an artifact reduction step.

15. The computed tomography system of claim 14, wherein only a subset of the density elements in the image are updated in each step, and/or wherein only a subset of the ray sums are used to update the image.
